(19) United States
(12) Patent Application Publication
(10) Pub. No.: US 2006/0279489 A1
(43) Pub. Date: Dec. 14, 2006

(54) Image display device and drive method for the same

(76) Inventors: Takayuki Ouchi, Hino (JP); Toshimitsu Watanabe, Yokohama (JP); Yoshiro Mikami, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/447,855

(22) Filed: Jun. 7, 2006

(30) Foreign Application Priority Data
Jun. 9, 2005 (JP) 2005-169381

(51) Int. Cl. G09G 3/30

(52) U.S. Cl. 345/76

(57) ABSTRACT

An image display device is provided in which the screen is partitioned into upper and lower areas both being driven simultaneously. Image data read out of a frame memory #1 is displayed in the upper area of the present screen and at the same time, image data of the preceding screen read out of a frame memory #3 is displayed in the lower area of the present screen. In the next screen, image data read out of a frame memory #2 is displayed in the upper area of the next screen and image data read out of the frame memory #1 is displayed in the lower area of the next screen. In this manner, the image data read out of the frame memory #1 is displayed consecutively over the present screen and the next screen.

### BACKGROUND OF THE INVENTION

The present invention relates to an image display device of passive matrix type constructed of devices featuring high-speed response, such as light emissive devices using organic light emitting diodes (OLED's), electron emission devices or ferroelectric liquid crystals and a method for driving the device.

As a test run of terrestrial digital broadcast starts, for preparation for coming regular run, studies on high definition and improvements on motion picture quality are making progress in connection with images of television. Meanwhile, with recent advance in various manufacture technologies, not only the conventional CRT but also a so-called flat panel type liquid crystal display (LCD) and a plasma display panel (PDP) are getting larger and larger in size.

But, problematically, the size increase leads to increased wiring resistance and the high definition gives rise to a decrease in process time per line which results in a decreased operational margin. And also, in the case of a display using devices based on so-called light emissive type high-speed response devices including, for example, a display using OLED's, field emission type displays (FED's) and electron emission type elements, that is, in the case of a display of passive matrix type which can be manufactured through a relative simplified production process in comparison with an active matrix type display using thin film transistors (TFT's), the brightness of the display is controlled by the luminescence period per line and brightness intensity.

Accordingly, high brilliance can be obtained by increasing the brightness intensity but this affects the life of a luminescent material and therefore, lower brightness per time is preferable.

As for the luminescence period, on the other hand, the time per one scanning line is determined by the degree of definition and is difficult to increase with ease. As one counterplot against this problem, a method described in JP-A-2001-209357 is available, according to which the display region is partitioned into upper and lower areas and the respective areas are driven simultaneously.

More specifically, the upper screen area is driven by a signal from an upper scanning line and a signal inputted from above and the lower screen area is driven by a signal from a lower scanning line and a signal inputted from below in order to enable the upper and lower screen areas to be driven at a time, with the result that the selection period per line can be doubled at the most and therefore doubled brightness can be delivered under the same condition.

### SUMMARY OF THE INVENTION

In this type of upper and lower partition drive, however, when the scanning direction is identical for the upper and lower areas, the luminescence timings differ greatly within one frame at mutually adjacent display areas around the boundary and specifically, in a display in which a longitudinal line moves laterally, a defective display of a disconnected longitudinal line is expected to occur. The contents of a concrete display defect will be described hereunder with reference to FIGS. 10A to 10E.

In ordinary television, a static image of 60 frames per second is displayed. An image in which a black longitudinal line moves horizontally at a uniform speed on the background in white color will be considered.

More particularly, when an image signal indicative of a longitudinal line moving horizontally from left to right at a uniform speed is inputted as shown in FIG. 10A, this line can be seen as shown in FIG. 10B with an ordinal display device but with the display device in which the screen partitioned into the upper and lower areas is driven, two oblique longitudinal lines disconnected in the middle are seen as moving as shown in FIG. 10C in the event that the scanning direction is from up to down in both the upper and lower areas.

This image display is attributable to a phenomenon that image data originally indicative of a discontinuous pattern as shown in FIG. 10A is recognized by the human brain interpolating continuous movement to visualize a horizontally moving image whereas because of the simultaneous scanning for the upper and lower areas, luminescence timings are belated to each other within one frame period, so that this delay in luminescence or light emission is recognized as a positional shift.

Where the amount of movement per frame is A pixels, the frame period referenced to the horizontal synchronizing period (1Ho) is 400Ho and the number of lines in each of the upper and lower display areas is 384Ho, a positional shift B recognized at the boundary between the first line and the 384-th line can be expressed by the following equation
B=A×(384−1)/400
on the assumption that the range within which man can follow a movement is approximately A<20 in consideration of individual difference.

Accordingly, taking an instance where 10 pixels move per frame, for instance, a shift of 9 to 10 pixels is recognized between the first line and 385-th line and between the 384-th line and 768-th line. Particularly, at the boundary between the 384-th line and 385-th line, the difference can be seen distinctively, resulting in a visibly disconnected longitudinal line.

A manner to consider a counterplot against the display defect as above has been reported according to which as shown in FIGS. 10D and 10E, the scanning directions are inversed to match timings of display at the boundary. Even with this counterplan, the disconnection at the connecting portion can be eliminated but the difference in luminescence timing between the center and each of the upper and lower ends still causes an inconvenient phenomenon as above, proving experimentally that the longitudinal line is seen as bent in “<” letter form as shown in FIG. 10D or 10E.

In the light of the above, the present invention is to eliminate a display defect which takes place when display is driven with the display region partitioned into upper and lower areas.

In the present invention, a counterplot against the aforementioned picture quality defect can be materialized without changing hardware to a large extent, that is, without increasing the number of parts such as frame memories, thus providing a television set exhibiting high picture quality at low costs.

According to the present invention, a method is provided which sequentially performs scanning for outputting an image signal in an upper area of the present screen and scanning for outputting an image signal in a lower area of the next screen, wherein an image signal of one frame divided into upper and lower areas in each of the present and next screens is outputted over two screens.

Typically, an image input signal is sectioned frame by frame with a vertical synchronizing signal so that image data of each frame may be stored in the same frame memory and processed but when the partition drive as in the present invention is employed, with the aim of curing the picture quality defect as seen at the boundary, the image input signal is sectioned at the screen partition portion and is stored in frame memories and besides an output process is so performed as to carry out a continuous display at the boundary.

According to the invention, in an image display device of passive matrix type, the image quality defect as seen during drive of the display region partitioned into upper and lower areas can be eliminated through optimization of output timing.

Further, according to the invention, by improving a method for storing an input image signal in a frame memory with a view to curing the picture quality defect, an image display device can be provided at low costs without being subject to a large extent of systematic change.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating an image display device according to embodiment 1 of the present invention.

FIG. 2 is a time chart useful to explain memory selection timing and scanning line selection condition in FIG. 1.

FIG. 3 is a schematic block diagram showing an image display device according to embodiment 2 of the invention.

FIG. 4 is a time chart for explaining memory selection timing and scanning line selection condition in FIG. 3.

FIG. 5 is a time chart for explaining timing of image data read/transfer from a frame memory according to embodiment 3 of the invention.

FIG. 6 is a diagram schematically showing a display region in the image display device according to embodiment 4 of the invention.

FIG. 7 is a diagram schematically showing another display region in the image display device according to embodiment 5 of the invention.

FIGS. 8A and 8B are enlarged views of a pixel for use in FIG. 7, showing the pixel in cross-sectional form and plan view form, respectively.

FIG. 9 is an enlarged cross-sectional view of a pixel in FIG. 6 according to embodiment 6 of the invention.

FIGS. 10A to 10E are diagrams illustrating how a moving longitudinal line is seen in the display device having upper and lower screen areas.

### DESCRIPTION OF THE EMBODIMENTS

Embodiments of the present invention will now be described with reference to the accompanying drawings, wherein like reference numerals designate like or corresponding parts.

### Embodiment 1

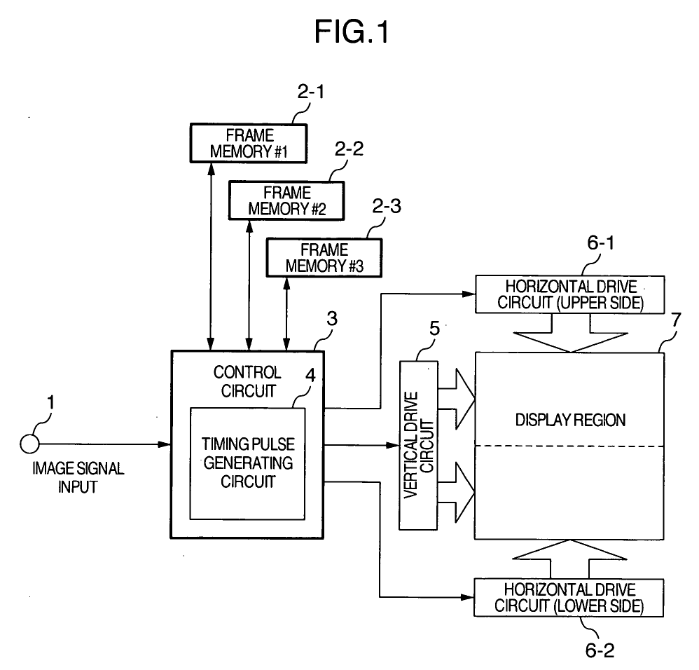

Referring first to FIG. 1 schematically showing an image display device according to this invention, an image signal input 1 is stored in any one of frame memories Nos. 1 to 3 as designated by reference numerals 2-1, 2-2 and 2-3 by way of a control circuit 3. On the other hand, a timing pulse generating circuit 4 in control circuit 3 generates and outputs timing pulses for driving a vertical drive circuit 5 connected to scanning lines in upper and lower partition display areas, concurrently generating and outputting timing pulses for driving horizontal drive circuits 6-1 and 6-2 connected to signal lines in the upper and lower partition display areas, respectively, and reads necessary image data from any of the frame memories #1 to #3 to deliver image signals to the upper and lower horizontal drive circuits 6-1 and 6-2. In a display region 7, individual pixels arranged in matrix in each of the upper and lower display areas are sequentially caused to luminesce by signals inputted through the scanning lines and signal lines, thus exhibiting a display.

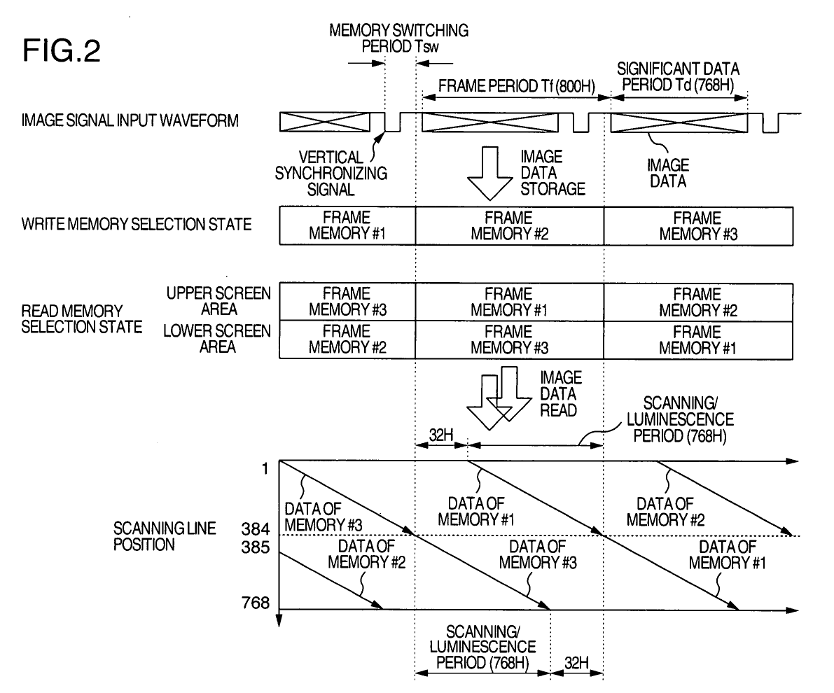

Turning now to FIG. 2, it will be seen that after significant data of the preceding frame has ended, a front porch period, a vertical synchronizing signal period and a back porch period proceed, followed by a significant (or valid or effective) data period and a period consisting of a series of these periods is collectively called a frame period Tf.

When taking a case of so-called WXGA having a display matrix of (1366 pixels in horizontal direction ×768 pixels in longitudinal direction), for instance, the frame period Tf is assumed to be 800 H referenced to the period of horizontal synchronizing signal (hereinafter referred to as 1 H), whereby with a significant data period Td of 768 H in mind, the front porch is 10 H, the vertical synchronizing signal is 6 H and the back porch is 16 H, thus being totaled to 32 H corresponding to an non-significant (insignificant) data period of each frame period.

The frame period Tf may be related to the significant data period Td pursuant to unified standards regulated by VESA but may otherwise comply with specifications specified to each device, eventually defining that Td/Tf is approximately 90% or more.

Operation for switching the frame memory #1 needs to be done before the significant data period Td starts and if this operation is carried out at the timing of 16H in the back porch period, a memory switching period Tsw for the frame memory #1 occupies 22H starting from inputting of the vertical synchronizing signal (6H), thus amounting to a value smaller than the insignificant data period 32H.

Following switchover of the frame memory #1, the frame memory #2 is dedicated to writing (reading) to store image data. On the other hands, in each of the frame memories #1 and #3 dedicated to reading, image data of the first to 384-th lines in the upper area is read sequentially from the frame memory #1 storing image data of the preceding frame and the readout data is delivered to the horizontal drive circuit. At the same time, image data of the 385-th to 768-th lines in the lower area is sequentially read out of the frame memory #3 storing image data of the two period preceding frame and delivered to the horizontal drive circuit.

To keep continuity of scanning over the upper and lower screen areas, image data in association with the 385-th line and ensuing lines in the lower screen area is delivered immediately after completion of switchover of the frame memory #1 and image data in association with the first line and ensuing lines in the upper screen area is delivered starting from 33 H which begins at the termination of 32H following the switchover.

Through the operation as above, after 800H has elapsed following the switchover, the frame memory #1 completes delivery of data associated with the 384-th line in the upper screen area and then delivers data associated with the 385-th line in the lower screen area of the next screen, so that the image data can be outputted in succession to thereby prevent such an image quality defect that a moving image at the boundary between the upper and lower screen areas is seen as being disconnected.

After the frame memory switchover, the frame memory dedicated to writing is changed from the frame memory #2 to the frame memory #3 and the frame memory dedicated to reading is changed from the frame memory #1 to the frame memory #2 in association with the upper screen area and from the frame memory #3 to the frame memory #1 in association with the lower screen area. Similar operation repeats itself each time that the frame period is over.

By performing scanning for the upper and lower divisional areas in this manner, the scanning/luminescence period per line can be 2H doubling the period in conventional drive and therefore, even under the same drive condition, that is, brightness intensity, the brightness can be doubled to realize a high-definition television.

### Embodiment 2

According to the present embodiment, in the image display device for exhibiting a display by using the upper and lower divisional screen areas as explained in connection with embodiment 1, pieces of image data of two frame memories are used in the present screen and in the next screen, the image data pieces of the frame memories used in the present screen are used to perform continuous scanning, thereby making it possible to suppress degradation in moving picture quality at the boundary.

Embodiment 1 is inconvenient in that image data from the same frame memory needs to be delivered over two screens and for continuous implementation of this operation, the frame memory must have a capacity of three frames and the necessary system configuration swells to raise costs.

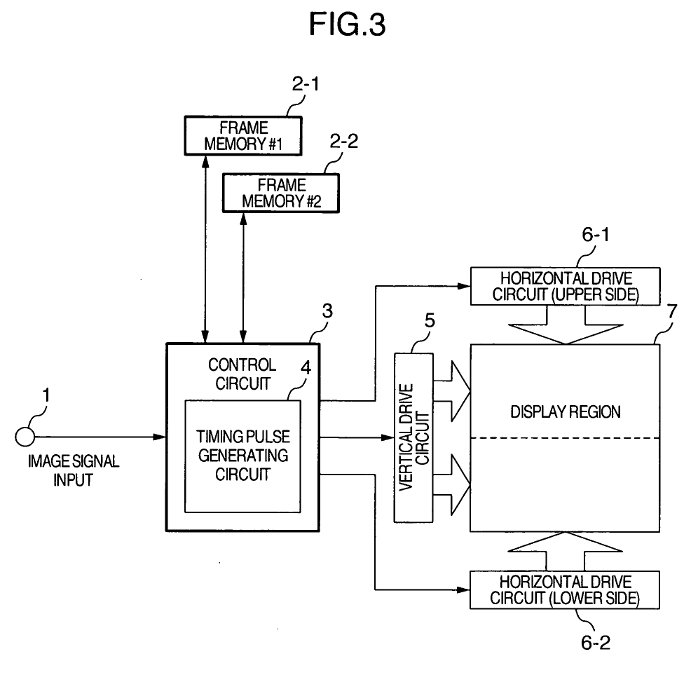

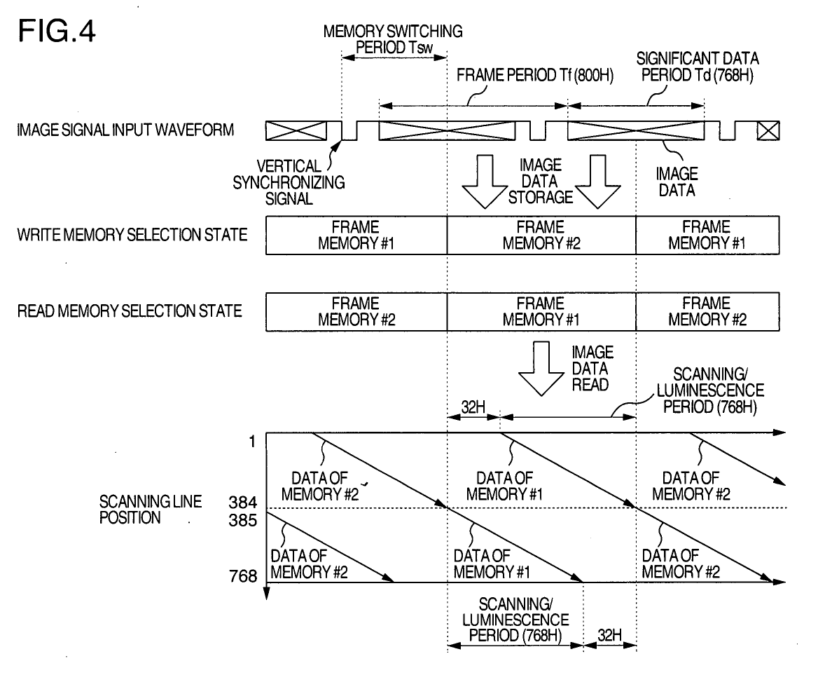

In the present embodiment, a capacity of frame memory for two frames can suffice as will be described with reference to FIGS. 3 and 4.

In contrast to the construction of FIG. 1, the frame memory in FIG. 3 has a capacity of two frames. As in the case of embodiment 1, the display region has a matrix of 1366 horizontal pixels×768 vertical pixels and is partitioned into independently controllable upper and lower areas each having 384 lines.

Reference will be made to FIG. 4 to describe operation. Like embodiment 1, it is assumed that in this system, the frame period Tf is 800H and significant data period Td is 768H and that front porch is 10H, vertical synchronizing signal is 6H and back porch is 16H, thus being totaled to 32H occupied by an non-significant data period.

Being different from embodiment 1, the present embodiment is so constructed that the timing for switchover of frame memory coincides with the end of the 384-th line in significant data period at which image data corresponding to the upper screen area ends. Then, memory switching period Tsw ranging from start of the vertical synchronizing signal to the frame memory switchover timing is 406H which is larger than the insignificant data period 32H.

After completion of switchover of the frame memory #1, the frame memory #2 is dedicated to writing and stores image data. On the other hand, since the frame memory #1 now dedicated to reading is storing image data associated with the first line to the 384-th line in the upper screen area of the present frame and image data associated with the 385-th line to the 768-th line in the lower screen area of the preceding frame, these pieces of image data are sequentially read in synchronism with scanning for the upper and lower screen areas and are outputted to the horizontal drive circuits.

As in the case of embodiment 1, to keep continuity of scanning between the upper and lower screen areas, image data in the lower screen area (associated with the 385-th line) is outputted immediately after the switchover of the frame memory and at 33H following the switchover, image data in the upper screen area is outputted.

In this manner, at the termination of 800H following the switchover, delivery of data associated with the 384-th line in the upper screen area is completed to continue to delivery of data associated with the 385-th line, thus assuring continuous delivery of image data so as to make it possible to prevent such a picture quality defect that a moving image is seen as being disconnected at the boundary between the upper and lower screen areas.

After completion of the frame memory switchover, the frame memory dedicated to writing is changed from the frame memory #2 to the frame memory #1 and the frame memory dedicated to reading is changed from the frame memory #1, which stores data associated with the first line to the 384-th line in the upper screen area of the present frame and data associated with the 385-th line to the 768-th line in the lower screen area of the preceding frame, to the frame memory #2 which stores data associated with the 385-th line to the 768-th line in the lower screen area of the present frame and data associated with the first line to the 384-th line in the upper screen area of the next frame. Subsequently, operation similar to the above repeats itself each time that the frame period renews.

In the system configuration according to the present embodiment, the frame memory can be for two frames, being one frame less than that in embodiment 1, to attain the same effect in point of moving picture quality and brightness, thus ensuring that an image display device of high definition can be obtained without changing the conventional hardware configuration extensively.

### Embodiment 3

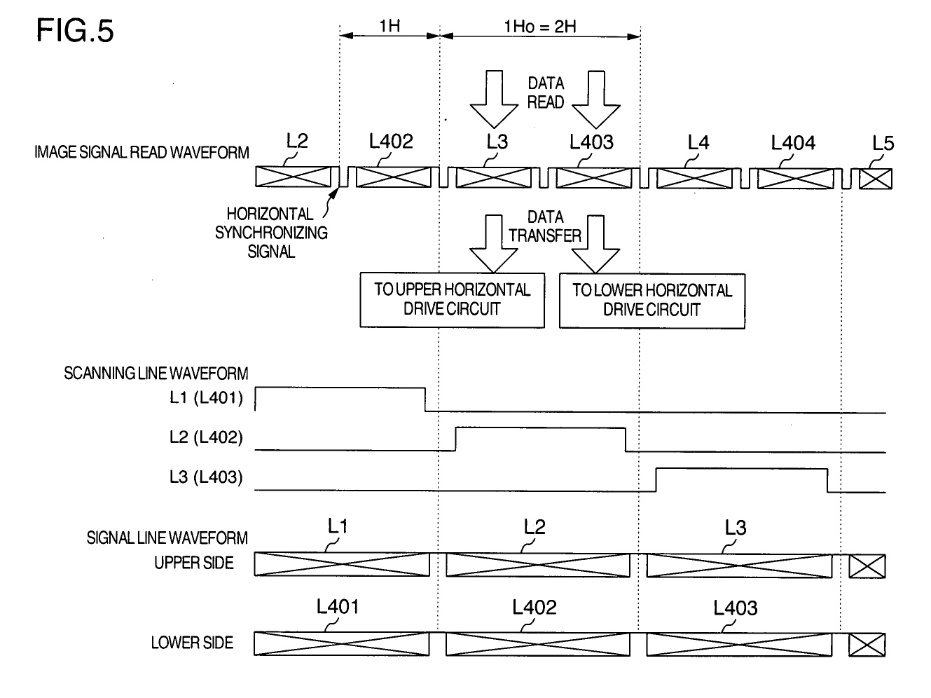

Next, embodiment 3 will be described by making reference to FIG. 5. Described in the present embodiment is a method of processing image data within a horizontal period more efficiently than in embodiment 1 or embodiment 2.

Where the horizontal synchronizing period of an image input signal is 1H, by virtue of partition of display region into upper and lower areas, the selective scanning period per line can be doubled and therefore, when the horizontal synchronizing period as viewed from the display system is 1Ho, 1Ho=2H stands. In other words, it suffices for the frame memory dedicated to reading to deliver image data associated with one line in each of the upper and lower areas during the period 2H.

The image data pieces may be delivered simultaneously at a low speed but in that case, busses for two lines need to be laid in relation to the control circuit and the system cost increases. During storage of the image input signal, image data associated with one line has already been processed within 1H and hence, during delivery of data, image data associated with one line may also be processed within 1H without changing the control system extensively.

Namely, by reading image data in the upper screen area within the first half 1H of horizontal synchronizing period 1Ho (=2H) in the display system and by reading and transferring image data in the lower screen area within the second half 1H, the control circuit of conventional construction can be used without alteration.

The image data transferred to the horizontal drive circuit in this manner sends its signals to pixels via individual signal lines at the beginning of the horizontal period 1Ho in the next display series. Synchronously therewith, the vertical drive circuit delivers a selective scanning pulse for one in each of the upper and lower display areas and each line selected in each of the upper and lower areas proceeds to a display condition at individual pixels on its own line.

The above procedures are illustrated in FIG. 5. In sequence of the first line, 401st line, second line, 402-th line, third line and 403-rd line, the frame memory dedicated to reading transfers, every 1H, image data associated with each line to each of the upper and lower horizontal drive circuits. Reading on the first line is followed not by reading on the 385-th line but by reading on the 401^{st} line because the non-luminescent period 32H intervenes as shown in FIGS. 2 or 4 to shift the head position in each of the upper and lower areas. The image data once held in the horizontal drive circuit delivers its signal waveform to each signal line every 1Ho. The scanning selective pulse delivers every 1Ho a selecting pulse for one line in each of the upper and lower areas.

The present embodiment has been described by giving an example where the image data read out of the frame memory is once held in the horizontal drive circuit and then delivered to a signal line during the next 1Ho period. But, in case an additional image process is carried out and delivery to a signal line is delayed by additional 1Ho period, the effect of the present invention can obviously be attained by 1Ho delaying the output timing of the scanning selective pulse.

The pixel is not particularly delimitative and as far as driving of passive matrix type is permitted, the effect similar to the above can obviously be obtained even when the electron emission type device, cathode nano-tube (CNT), surface conduction electron emitter (SCE) or organic light emitting diode (OLED) is used.

### Embodiment 4

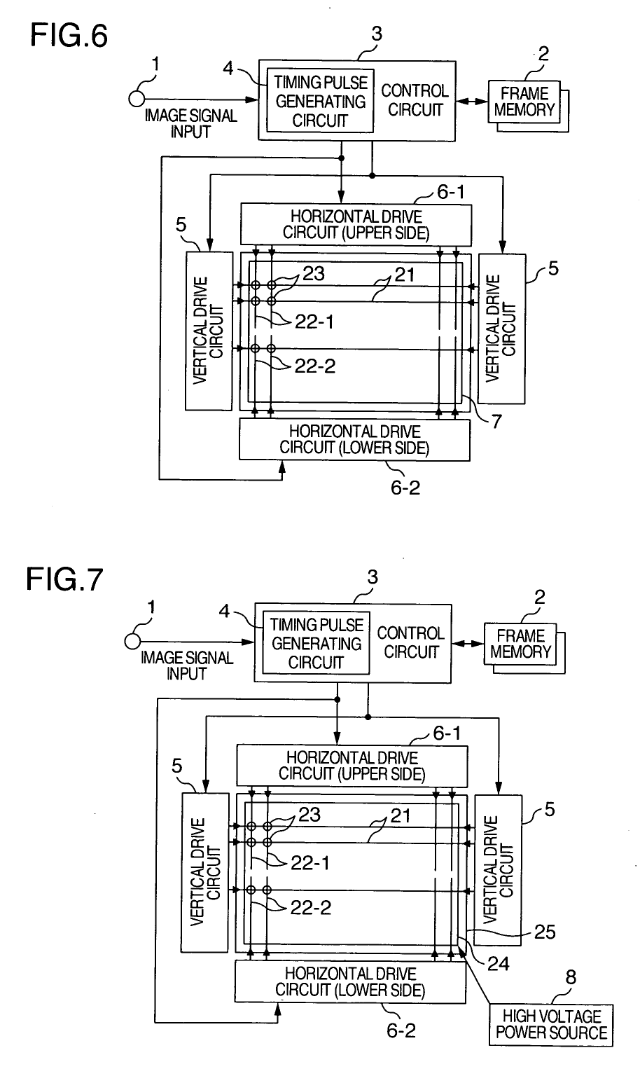

Turning now to FIG. 6, embodiment 4 will be described. In the present embodiment, the construction of the display region will be explained in connection with the image display device for realizing the drive method explained in embodiments 1 to 3.

The image display device according to the present invention is schematically illustrated in FIG. 6, showing an image signal 1 which is inputted to the control circuit 3 and stored in the frame memory 2. A control signal from a timing pulse generating circuit 4 provided in the control circuit 3 is sent to the right and left vertical drive circuits 5 and the upper and lower horizontal drive circuits 6-1 and 6-2. Image data from the frame memory 2 is sent to the horizontal drive circuits 6-1 and 6-2.

The display region 7 is connected, on its substrate, to scanning wiring conductors 21 connected to the vertical drive circuits 5 and to the upper and lower horizontal drive circuits 6-1 and 6-2 and is laid with upper and lower separated signal wiring conductors 22-1 and 22-2. At intersections of individual scanning wiring conductors 21 and individual signal wiring conductors 22, pixels 23 are arranged in matrix. Accordingly, each pixel 23 changes in brightness in accordance with image data applied to a signal wiring conductor 22 during a period selected by each scanning wiring conductor 21.

### Embodiment 5

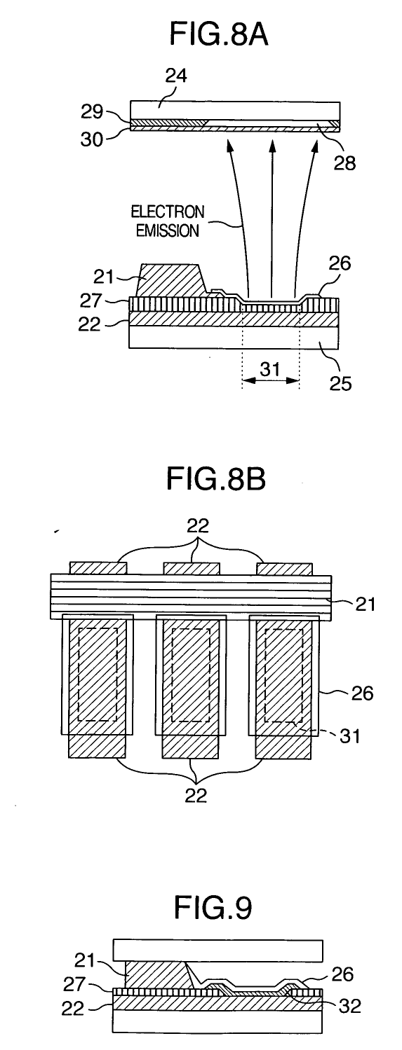

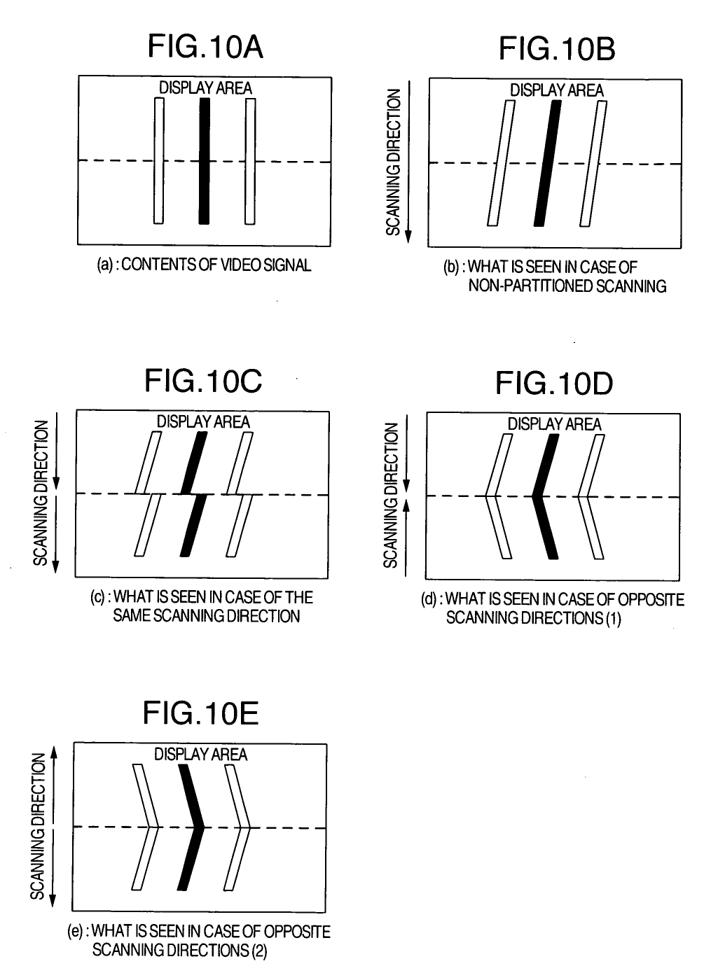

Embodiment 5 will be described with reference to FIG. 7 and FIGS. 8A and 8B. In the present embodiment, a description will be given of another type of construction of the image display device for realizing the drive method explained in connection with the embodiments 1 to 3.

The image display device according to the invention schematically illustrated in FIG. 7 differs from FIG. 6 in that in the display regions an anode substrate 24 having fluorescent or phosphor materials and a cathode substrate 25 having an electron emission source are spaced apart to confront each other and bonded to each other with a constant distance therebetween to form a cavity which is evacuated to low pressure and the anode substrate 24 is supplied from a high voltage power source 8 with a high voltage for accelerating emitted electrons.

The cathode substrate 25 is connected with scanning wiring conductors 21 connected to the vertical drive circuit 5 and with the upper and lower horizontal drive circuits 6-1 and 6-2 and laid with signal wiring conductors 22-1 and 22-2 separately provided for the upper and lower areas. Pixels 23 are arranged in matrix at intersections of the individual scanning wiring conductors 21 and the individual signal wiring conductors 22.

It will be appreciated that in FIGS. 1, 3, 6 and 7, the control circuit 4 and frame memory 2 are illustrated as being separated from each other for convenience of mere explanation of the function of this invention and in practical hardware construction, for example, the control circuit 4 and frame memory 2 may be mounted on a single control substrate or part of the vertical drive circuit 5 and part of the horizontal drive circuit 6 may be packaged on the control substrate, obviously attaining the effect of the invention similarly.

The pixel 23 is illustrated in sectional form in FIG. 8A. Signal wiring conductors 22 formed on a cathode substrate 25 is separated, through the medium of an insulating film 27, from scanning wiring conductors 21 formed thereon. Part of the insulating film 27 is formed into a very thin film having a thickness of about 10 nm and a thin upper electrode 26 is formed on this very thin part and connected to the scanning wiring conductors 21.

This type of structure in which the signal wiring (lower electrode) 22, (very thin) insulating film 27 and upper electrode 26 are stacked in this order is called an MIM (metal insulator metal) structure which exhibits diode characteristics in relation to applied voltage and permits part of electrons to be emitted to above the upper electrode.

With this structure, the MIM portion is used as an electron emission source 31, emitted electrons are accelerated by a high voltage applied to the opposing anode electrode 24 so as to collide on phosphor materials 28 on the substrate to cause them to luminesce. The anode substrate 24 is additionally comprised of black matrix 29 for inter-pixel separation and metal back 30 for directing a backward component (toward the cathode substrate) of luminescence at the phosphor materials 28 to the top surface.

The pixel 23 on the cathode substrate is illustrated in plan view form in FIG. 8B, showing that the signal wiring conductor 22 orthogonal to the scanning wiring conductor 21 is electrically separated therefrom by an insulating film. The insulating film is thinned above the signal wiring conductor as shown in FIG. 8A at an area where the electron source 31 is formed and the upper electrode 26 is formed to cover this area and connected to the signal wiring conductor 21. When phosphor materials for red, green and blue corresponding to the individual electron sources are arranged in regular order on the anode substrate, a color image display device can be obtained.

By using the image display device constructed as above to manipulate the drive method described in connection with embodiments 1 to 3, a high-definition and high-brightness, flat-panel display can be materialized. In the present embodiment, the flat-panel MIM element is used as electron source 31 but the electron source 31, provided that it meets emission of electrons toward the anode substrate 24, is in no way limited to the MIM element. In other words, carbon nano-tube (CNT) or surface charge emitter (SCE) can obviously be used as the constituent to attain similar effects.

### Embodiment 6

By making reference to FIG. 9, embodiment 6 will be described. The present embodiment is directed to the use of an OLED (organic light emitting diode) as pixel 23 in the image display device constructed as explained in connection with embodiment 4.

The pixel 23 shown in FIG. 6 is materialized with an OLED as illustrated in sectional form in FIG. 9, demonstrating that a lower electrode (also serving as signal electrode 22) is formed on a transparent substrate made of, for example, glass by using a transparent electrode made of, for example, ITO or IZO, an opening is formed in an insulating film 27 and a scanning wiring conductor 21 is formed by using a metal material of low resistivity such as Al.

Next, an OLED element of single layer or multi-layer structure having the function of positive hole injection layer, positive hole transporting layer, emission layer, electron transporting layer and electron injection layer is formed in the opening and besides, an upper electrode 26 is so formed through, for example, vapor deposition process as to be connected to the scanning wiring conductor 21. Finally, a passivation film or glass substrate playing the role of a protective layer is bonded.

With this structure, by applying a voltage across the upper electrode 26, OLED 32 and lower electrode (signal wiring conductor 22), the OLED layer can luminesce in accordance with the voltage and rays of light are emitted toward the lower substrate.

In this manner, an image display device having pixels of OLED's in matrix can be provided. While in the present embodiment a bottom emission structure is exemplified in which light is emitted to the ground substrate forming the OLED 32, a pixel of a top emission structure having a transparent electrode arranged on the upper side to extract light in the opposite direction may be used to construct a panel as shown in FIG. 6, assuring that an image display device according to the present invention can obviously be materialized.

It should be further understood by those skilled in the art that although the foregoing description has been made on embodiments of the invention, the invention is not limited thereto and various changes and modifications may be made without departing from the spirit of the invention and the scope of the appended claims.

1. An image display device adapted to receive consecutive image data frame by frame and store the image data by sequentially switching two frame memories,
wherein switchover between said two frame memories is carried out during storage of image data for each frame.

2. An image display device according to claim 1 having its display region comprised of M+N scanning lines, upper signal lines intersecting M scanning lines, lower signal lines intersecting N scanning lines and pixels connected in matrix to individual scanning lines and individual signal lines at individual intersections, each of said upper signal lines being connected to an upper horizontal drive circuit and each of said lower signal lines being connected to a lower horizontal drive circuit,
wherein switchover between said frame memories is timed to succeed storage of image data for the M lines in one frame memory, with the remaining image data for the N lines being stored in the other frame memory.

3. An image display device adapted to receive consecutive image data frame by frame and store the image data by sequentially switching two or more frame memories, comprising:
a display region including M+N scanning lines, upper signal lines intersecting M scanning lines, lower signal lines intersecting N scanning lines and pixels connected in matrix to individual scanning lines and individual signal lines at individual intersections, each of said upper signal lines being connected to an upper horizontal drive circuit and each of said lower signal lines being connected to a lower horizontal drive circuit and said M+N scanning lines being connected to a vertical drive circuit having the ability to selectively scan upper M lines and lower N lines independently of each other,
wherein selective scan of (M+1)-th line following completion of selective scan of upper M-th line is carried out during the next selective scan period.

4. An image display device according to claim 2, wherein in reading image data from said frame memories, data for one line in the upper M lines and data for one line in the lower N lines are read alternately at the same period as a horizontal synchronizing period for image data and the data for one line in the upper M lines and the data for one lines in the lower N lines are transferred to said upper horizontal drive circuit and lower horizontal drive circuit, respectively.

5. An image display device according to claim 1, wherein one substrate having wiring of the scanning lines and signal lines and formed with pixels arranged in matrix at intersections of said scanning lines and signal lines and the other substrate opposing said one substrate and formed with phosphor materials whose luminescence intensity is controlled by the amount of emitted electrons are spaced apart with a predetermined distance therebetween to form a cavity which is evacuated to low pressure, and
wherein said pixel is controlled in amount of electrons emitted thereby by a selective voltage from the scanning line and a voltage indicative of image data from the signal line so that the luminescence intensity of the phosphor material may be controlled to display an image.

6. An image display device according to claim 1, wherein said pixel includes an organic light emitting diode controlled in luminescence intensity by a selection voltage from the scanning line and a voltage indicative of image data from the signal line.

7. A method of driving an image display device having a screen partitioned into upper and lower screen areas which are driven simultaneously,
wherein upper part of the present image data is displayed on the upper screen area of the present screen and image data for the lower screen area of the preceding screen is displayed on the lower screen area of the present screen, and in the next screen, upper part of image data for the next screen is displayed in the upper screen area of the next screen and lower part of the present image data is displayed in the lower screen area of the next screen, thereby ensuring that the present image data is displayed consecutively over the present screen and the next screen.

8. An image display device according to claim 1,
wherein one substrate having wiring of the scanning lines and signal lines and formed with pixels arranged in matrix at intersections of said scanning lines and signal lines and the other substrate opposing said one substrate and formed with phosphor materials whose luminescence intensity is controlled by the amount of emitted electrons are spaced apart with a predetermined distance therebetween to form a cavity which is evacuated to low pressure, and
wherein said pixel is controlled in amount of electrons emitted thereby by a selective voltage from the scanning line and a voltage indicative of image data from the signal line so that the luminescence intensity of the phosphor material may be controlled to display an image.

9. An image display device according to claim 1, wherein said pixel includes an organic light emitting diode controlled in luminescence intensity by a selection voltage from the scanning line and a voltage indicative of image data from the signal line.

10. An image display device according to claim 2,
wherein one substrate having wiring of the scanning lines and signal lines and formed with pixels arranged in matrix at intersections of said scanning lines and signal lines and the other substrate opposing said one substrate and formed with phosphor materials whose luminescence intensity is controlled by the amount of emitted electrons are spaced apart with a predetermined distance therebetween to form a cavity which is evacuated to low pressure, and
wherein said pixel is controlled in amount of electrons emitted thereby by a selective voltage from the scanning line and a voltage indicative of image data from the signal line so that the luminescence intensity of the phosphor material may be controlled to display an image.

11. An image display device according to claim 2, wherein said pixel includes an organic light emitting diode controlled in luminescence intensity by a selection voltage from the scanning line and a voltage indicative of image data from the signal line.

12. An image display device according to claim 3, wherein in reading image data from said frame memories, data for one line in the upper M lines and data for one line in the lower N lines are read alternately at the same period as a horizontal synchronizing period for image data and the data for one line in the upper M lines and the data for one lines in the lower N lines are transferred to said upper horizontal drive circuit and lower horizontal drive circuit, respectively.

13. An image display device according to claim 3,
wherein one substrate having wiring of the scanning lines and signal lines and formed with pixels arranged in matrix at intersections of said scanning lines and signal lines and the other substrate opposing said one substrate and formed with phosphor materials whose luminescence intensity is controlled by the amount of emitted electrons are spaced apart with a predetermined distance therebetween to form a cavity which is evacuated to low pressure, and
wherein said pixel is controlled in amount of electrons emitted thereby by a selective voltage from the scanning line and a voltage indicative of image data from the signal line so that the luminescence intensity of the phosphor material may be controlled to display an image.

14. An image display device according to claim 3, wherein said pixel includes an organic light emitting diode controlled in luminescence intensity by a selection voltage from the scanning line and a voltage indicative of image data from the signal line.

15. An image display device according to claim 12,
wherein one substrate having wiring of the scanning lines and signal lines and formed with pixels arranged in matrix at intersections of said scanning lines and signal lines and the other substrate opposing said one substrate and formed with phosphor materials whose luminescence intensity is controlled by the amount of emitted electrons are spaced apart with a predetermined distance therebetween to form a cavity which is evacuated to low pressure, and
wherein said pixel is controlled in amount of electrons emitted thereby by a selective voltage from the scanning line and a voltage indicative of image data from the signal line so that the luminescence intensity of the phosphor material may be controlled to display an image.

16. An image display device according to claim 12, wherein said pixel includes an organic light emitting diode controlled in luminescence intensity by a selection voltage from the scanning line and a voltage indicative of image data from the signal line.
